(19) United States
(12) Patent Application Publication
(10) Pub. No.: US 2013/0291130 A1
(43) Pub. Date: Oct. 31, 2013

(54) Protection of Memory Field Using Illegal Values

(71) Applicants: Lior Amarilio, Yokneam (IL); Uri Bear, Pardes-Hana (IL); Reuven Elbaum, Haifa (IL); Yigal Shapiro, Zichron Yaakov (IL); Chaim D. Shen-Orr, Haifa (IL); Zvi Shkedy, Karmiel (IL); Yonatan Shlomovich, Givat Ada (IL)

(72) Inventors: Lior Amarilio, Yokneam (IL); Uri Bear, Pardes-Hana (IL); Reuven Elbaum, Haifa (IL); Yigal Shapiro, Zichron Yaakov (IL); Chaim D. Shen-Orr, Haifa (IL); Zvi Shkedy, Karmiel (IL); Yonatan Shlomovich, Givat Ada (IL)

(73) Assignee: Cisco Technology Inc., San Jose, CA (US)

(21) Appl. No.: 13/978,988

(22) PCT Filed: Dec. 6, 2011
(86) PCT No.: PCT/IB2011/055478

§ 371 Date: Jul. 15, 2013

Related U.S. Application Data
(60) Provisional application No. 61/461,597, filed on Jan. 20, 2011.

(30) Foreign Application Priority Data
Jan. 19, 2011 (GB) 1100887.7

(51) Int. Cl. G06F 21/60

(52) U.S. Cl. CPC G06F 21/60
USPC 726/30

(57) ABSTRACT

An electronic device (22, 72) includes an array (24, 74) of memory cells, including at least one range of the cells in which at least one cell (38, 40, 76) is permanently fixed during manufacture of the device to have a given value, while others of the cells are permitted to be programmed subsequently. A readout circuit (26) is configured to concurrently read out all the cells in the range, including the at least one permanently-programmed cell and the subsequently-programmed cells.

### FIELD OF THE INVENTION

The present invention relates generally to data security, and specifically to protection of electronic devices and data stored in such devices against unauthorized access and tampering.

### BACKGROUND OF THE INVENTION

Integrated circuit devices that contain a non-volatile memory (NVM) array, such as flash or one-time programmable (OTP) memory, are typically supplied by the manufacturer with at least a part of the memory unprogrammed. In this state, the memory cells store “virgin” (default) bit values, typically all ones or all zeroes. While the device is in this unprogrammed condition, it may be possible write to or read from any field in the memory.

System manufacturers incorporate these integrated circuits into their products and afterwards, typically program at least a part of the NVM array. A certain group of cells may be programmed as a security configuration field, to hold a data value that is used in controlling access to the memory and/or other system functions. Hackers may attempt to change the values read out of the security configuration field in order to tamper with the memory, read the memory content, or otherwise gain control of the system.

### SUMMARY

Embodiments of the present invention that are described hereinbelow provide techniques that can be useful in enhancing the tamper-resistance of electronic devices.

There is therefore provided, in accordance with an embodiment of the present invention, an electronic device, including an array of memory cells, including at least one range of the cells in which at least one cell is permanently fixed during manufacture of the device to have a given value, while others of the cells are permitted to be programmed subsequently. A readout circuit is configured to concurrently read out all the cells in the range, including the at least one permanently-programmed cell and the subsequently-programmed cells.

In disclosed embodiments, a readout in which the at least one cell has a value different from the given value is defined as an illegal readout. The at least one cell may include at least a first cell that is permanently fixed at a first value and at least a second cell that is permanently fixed at a second value.

There is also provided, in accordance with an embodiment of the present invention, an electronic device, including a readout circuit, which is configured to read one or more fields of data out of the device. Each field includes multiple bits, each configured to have either a first or a second value. The one or more fields include a protected field for which a readout in which all the bits have the first value is defined as an illegal readout. An array of memory cells is coupled to the readout circuit and configured to hold the bits of the one or more fields. At least one cell in the protected field is permanently fixed during manufacture of the device to have the second value, while others of the cells in the protected field are permitted to be programmed subsequently.

Typically, the readout circuit is configured to read out all the cells in the protected field concurrently from the electronic device.

In a disclosed embodiment, for the protected field, a first readout in which the bits are all zero and a second readout in which the bits are all one are defined as illegal readouts, and among the cells of the protected field in the array, at least a first cell is fixed to be permanently one and at least a second cell is fixed to be permanently zero.

Typically, the array of the memory cells is configured to store data content in the others of the cells that are permitted to be programmed subsequently. The data content may include a security configuration field value.

In one embodiment, the array contains one or more rows of the memory cells, and the at least one cell is located in one of the rows. In another embodiment, the at least one cell is located outside the rows of the array. The readout circuit may then include first sense amplifiers for reading out the data stored in the array, and at least one second sense amplifier for reading out the at least one cell.

There is additionally provided, in accordance with an embodiment of the present invention, a method for data protection. The method includes, in an array of memory cells in an electronic device, permanently fixing during manufacture at least one cell in a range of the cells to have a given value, while others of the cells are permitted to be programmed subsequently. A readout circuit is configured to concurrently read out all the cells in the range, including the at least one permanently-programmed cell and the subsequently-programmed cells.

There is further provided, in accordance with an embodiment of the present invention, a method for data protection, which includes identifying a protected field in an array of memory cells in an electronic device. The protected field includes multiple bits, each configured to have either a first or a second value. A readout from the protected field in which all the bits have the first value is defined as an illegal readout. At least one cell in the protected field is permanently fixed during manufacture of the device at the second value, while permitting others of the cells in the protected field to be programmed subsequently.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an electronic system, in accordance with an embodiment of the present invention;

FIG. 2 is a flow chart that schematically illustrates a method for protection of an electronic device against tampering, in accordance with an embodiment of the present invention; and

FIG. 3 is a block diagram that schematically illustrates an electronic system, in accordance with another embodiment of the present invention.

### DETAILED DESCRIPTION OF EMBODIMENTS

As noted earlier, system manufacturers often program certain fields in the memory of a device used in their system to serve as a security configuration field, holding a certain specified data value. In some types of attacks, a hacker may attempt to alter the value read out from the security configuration field by applying one or more (external) disturbances. Specifically, hackers sometimes attempt to cause the readout to contain all ones or all zeros, corresponding to the virgin bit values in the unprogrammed memory. Upon receiving these virgin values from the memory, the system may grant the hacker access to system functions, such as reading and/or writing values in the memory, that would ordinarily be blocked were the correct value read out from the security configuration field.

Some embodiments of the present invention that are described hereinbelow foil such attacks by identifying a certain field in a memory, such as the above-mentioned security configuration field, as a protected field, and defining a readout from this field in which all the bits have the same value as an illegal readout, which is typically one of a set of predefined illegal readouts. This predefined illegality may apply to a readout that contains either all ones or all zeros, or to both of these field values (<000 . . . 00> and <111 . . . 11>). Alternatively or additionally, there may be other readouts that are defined as illegal in this context. The system is designed to recognize the field value or values in question as illegal, and may take protective action when the illegal values do occur.

To enable this sort of protection, the system is designed so that the illegal field value will occur only as the result of an attack or other fault, and not in normal operation. For this purpose, at least one of the bits in the protected field is designed and manufactured with a permanently fixed value, so that the field value will not be the illegal value under normal circumstances. In other words, if the illegal value is all zeros, then at least one bit is permanently stuck at one, and vice versa; and if both all ones and all zeroes are illegal values, then at least one bit is permanently stuck at one, and at least one other bit is permanently stuck at zero. Thus, as long as the readout circuit is operating normally, the illegal value or values will never be read out from the protected field. This approach consumes some memory space and readout bandwidth, but it makes certain types of attacks infeasible.

More generally speaking, embodiments of the present invention may be directed to protecting any range in an array of memory cells in an electronic device. The “array” may comprise a matrix of cells, or it may simply comprise a register or other group of cells, which may be non-volatile or volatile; and the range may comprise any part of the array or the entire array (particularly in the case of protected registers). At least one cell in the protected range is permanently fixed during manufacture of the device to have a given value, while others of the cells are permitted to be programmed subsequently. All the cells in the range, however, are read out of the device concurrently—including both the permanently-programmed and the subsequently-programmed cells.

The device is configured so that attacks on the protected range will affect the readout from the permanently-programmed cell or cells in a manner similar to their effect on the subsequently-programmed cells. (Some example configurations of this sort are described below.) Consequently, any readout in which the permanently-programmed cells give values different from their fixed values will be indicative of an attack (or at the very least a serious malfunction), regardless of the precise nature of the attack. Therefore, readouts in which the permanently-programmed cells have values different from their fixed values are defined as illegal readouts and are treated accordingly.

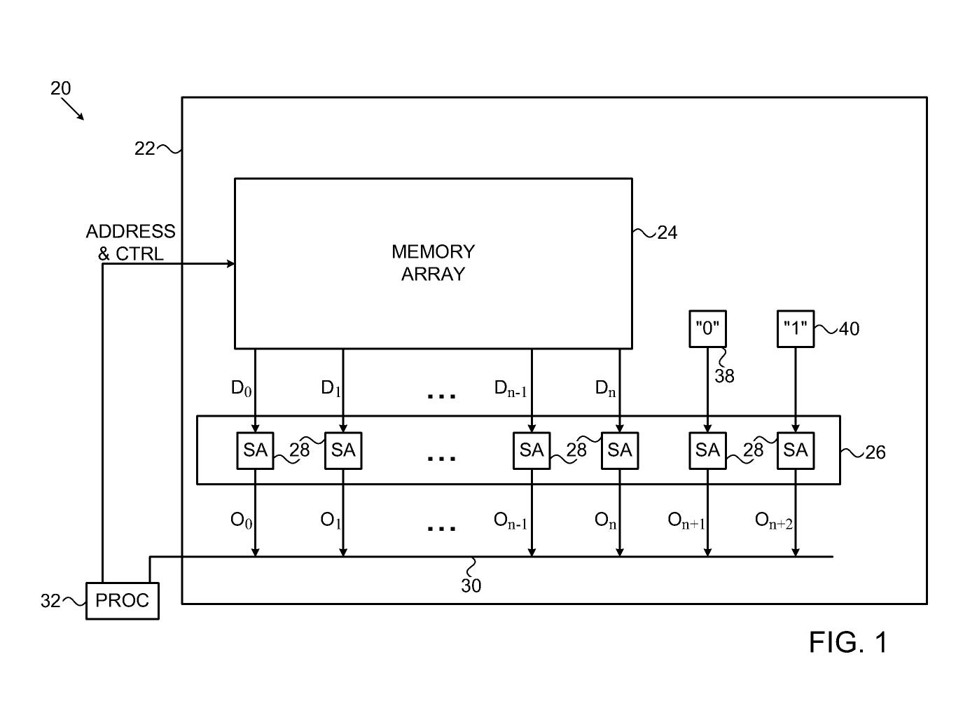

FIG. 1 is a block diagram that schematically illustrates an electronic system 20, in accordance with an embodiment of the present invention. The term “system” is used here to refer to substantially any type of electronic apparatus that may be subject to data security concerns, from micro-systems such as smart cards and disk-on-key devices, through television set-top boxes, desktop computers, servers, and other types of computerized apparatus. System 20 is simplified in the figure to show only certain components that are useful in understanding the operation of this embodiment.

System 20 comprises an electronic device 22 containing a memory array 24 with a readout circuit 26. Memory array 24 may comprise substantially any kind of volatile or non-volatile memory, which may be as small as one or more programmable cells (including OTP cells) or a single register, or may comprise a large array of read-only memory (ROM), random-access memory (RAM), or non-volatile RAM (NVRAM), such as flash memory. Readout circuit 26 in this embodiment comprises an array of sense amplifiers 28, which receive input bit values D₀, D₁, . . . , Dₙ from cells in corresponding columns of array 24 and generate output bit values O₀, O₁, . . . , Oₙ to a data bus 30, as is known in the art. A processor 32, such as an embedded or freestanding microprocessor or other logic device, inputs address and control commands to device 22 and receives the data readout from bus 30. A certain field in memory array 24 is identified as a security configuration field and may be read out by processor 32 as a indication, for example, of access permission to device 22 or other system functions.

By manipulating power, ground and/or control lines in system 20, a hacker may be able to cause the bit values D₀, D₁, . . . , Dₙ to be all zero level or all one level. As a result, the output O₀, O₁, . . . , Oₙ will be <00 . . . 0> or <11 . . . 1> for all fields read from memory array 24, including the security configuration field.

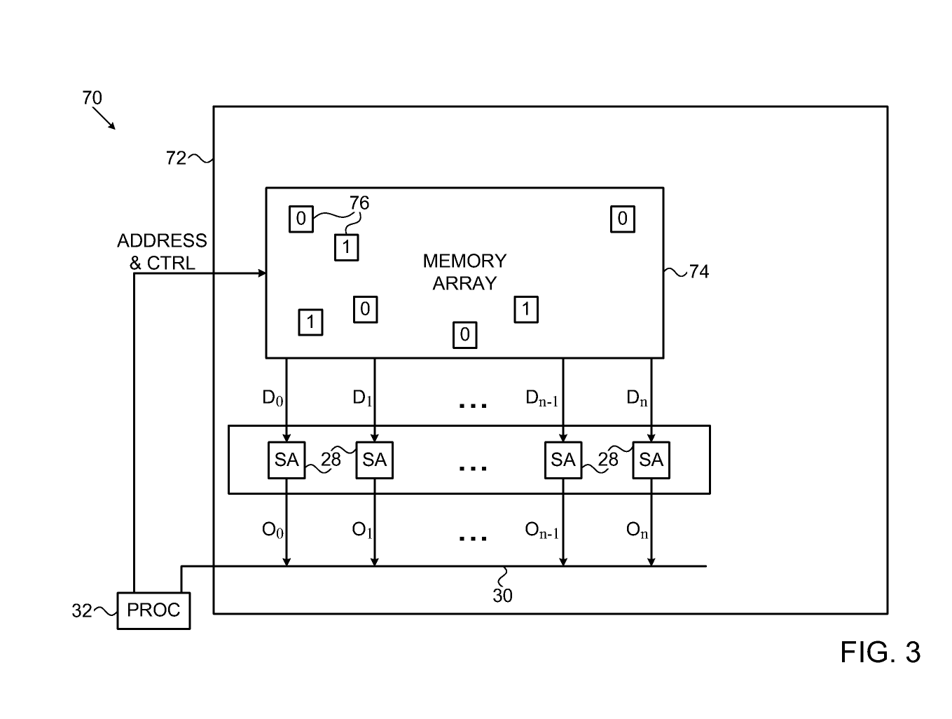

In order to handle this sort of eventuality, stuck bits 38 and 40 are added to array 24. Bits 38 and 40 are shown in FIG. 1, for the sake of clarity, as separate memory elements with their own sense amplifiers 28 and storage locations outside the rows of memory array 24; but they may still be considered a part of memory array 24 regardless of this physical separation. Furthermore, in other embodiments, such as that shown in FIG. 3, the stuck bits may actually be physically integrated with array 24, with storage locations in a row or rows of the array. Bit 38 is permanently fixed (equivalently, “burned” or “stuck,” i.e., programmed with a fixed value that cannot afterwards be changed) at the value zero, while bit 40 is permanently fixed at the value one. As a result, as long as device 22 operates properly and bits 38 and 40 receive the appropriate voltage from the power bus in device 22, the respective sense amplifiers 28 will output respective values Oₙ₊₁=0 and Oₙ₊₂=1 to bus 30. Therefore, processor 32 may be programmed to recognize that all legal words read from bus 30 (including the security configuration field) must have the form <O₀, O₁, . . . , Oₙ, 0, 1>.

The words <00 . . . 000> and <11 . . . 111> are defined as illegal. Such words will appear on bus 30 only when a malfunction, due to tampering with device 22 or to other circumstances, causes bit 40 to output the value zero or bit 38 to output the value one. Processor 32 may be programmed to take protective action upon receiving one of these illegal words, such as issuing an alarm and/or shutting down system 20 to prevent unauthorized access to the data in memory array 24.

Although bits 38 and 40 in device 22 provide protection against attacks that may cause all zeros or all ones to appear on bus 30, in practice it may be sufficient to protect against only one of these illegal words. In such cases, device 22 may contain either bit 38 or bit 40, as appropriate, but need not contain both. Alternatively, device 22 may contain two or more bits that are stuck at zero, or two or more bits that are stuck at one, or both, as dictated by application requirements.

Furthermore, although the embodiment of FIG. 1 relates to protection of the output interface of device 22 and of memory array 24 specifically, the principles of this embodiment and of the methods and alternative embodiments described below may similarly be applied to other sorts of data interfaces, such as signal lines, buses, registers and register banks, as well as functional unit outputs.

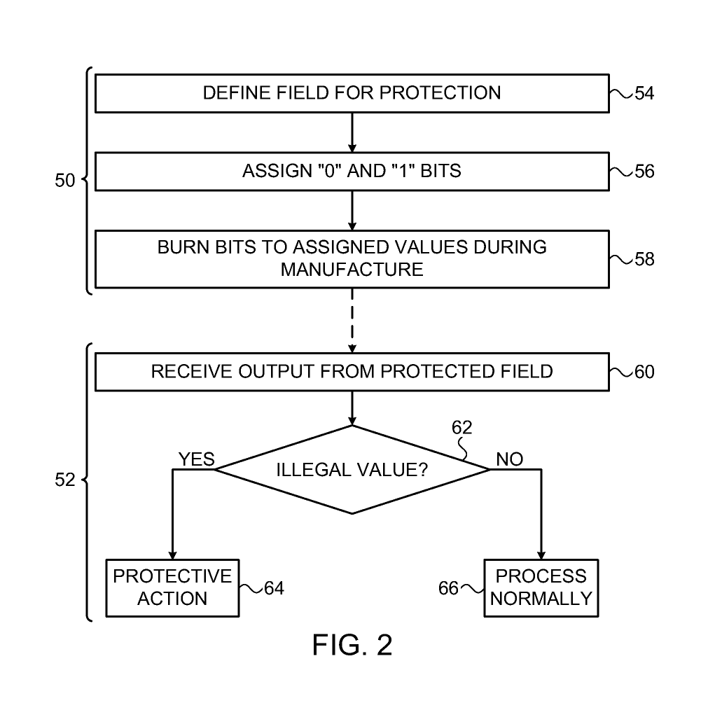

FIG. 2 is a flow chart that schematically illustrates a method for protection of an electronic device against tampering, in accordance with an embodiment of the present invention. This method is applicable to device 22 but may equally be applied in other devices in which protection of a certain field or fields in memory is desired. It includes two stages: a production phase 50, which typically takes place in the factory, and an operating phase 52, which may take place subsequently in an operational environment. The production phase includes both design (steps 54 and 56) and manufacturing activities (step 58).

During production phase 50, a field that is to be protected is identified, at a field definition step 54. The protected field may be a security configuration field, as described above, or any other field in a memory of the device in question. The term “field” is used in the context of the present patent application and in the claims in its conventional sense, to mean an ordered set of bits, having respective bit values, of some predefined length. The locations of the bits of the field need not be physically contiguous in the memory. A single field or multiple fields, of any suitable length, may be identified for protection in this manner.

Assuming both all zeros and all ones are to be considered illegal values of the protected field, one or more bits of the field are assigned to be zero bits, and one or more other bits are assigned to be one bits, at a bit assignment step 56. The assigned bits may be physically located among the data bits of the memory, or they may alternatively be separated from the data memory, as shown in FIG. 1. The device is then prepared by permanently fixing the assigned bits to the appropriate “0” and “1” values, at a bit burning step 58. For example, these bits may be produced by appropriate configuration of the lithographic mask during the integrated circuit manufacturing process by which the device is produced, or using any other suitable manufacturing technique, whether during wafer fabrication or at a later stage in the manufacturing process. Although these assigned bits are stuck at their permanent values, the remaining bits of the protected field may be programmed with data content in the factory, and possibly in the operational environment, as well. In other words, the protected field mixes fixed and programmable bit values.

During operating phase 52, the programmed device typically receives inputs and provides outputs and may access and output values from the protected field from time to time, at a field reading step 60. All the bits of the field are typically read out concurrently (at exactly the same time) from the device. A processor, such as an embedded or independent microprocessor or other logic device, checks the readout from the protected field, at a bit checking step 62. If all the bits have the same value (all ones or all zeros), the processor (as defined above) recognizes the readout as illegal and takes appropriate protective action, as described above, at a protection step 64. Otherwise, the processor handles the readout normally, and continues with ordinary operations, such as reading and using data, as well as writing to array 24, at a normal processing step 66.

FIG. 3 is a block diagram that schematically illustrates an electronic system 70, in accordance with another embodiment of the present invention. System 70 comprises an electronic device 72 containing a memory array 74. Other elements shown in FIG. 3 are similar to the corresponding elements of system 20 (FIG. 1) and are marked with the same numbers.

Memory array 74 comprises memory cells, which are arranged and read out in multiple rows. Some or all of these rows contain permanently-fixed bits 76. The remaining bits may be programmed with data content. When processor 32 accesses a range in array 74 that contains one or more of bits 76, the values of these bits are read out together with the data from the range. The processor checks that bits 76 have the proper, assigned values in the readout. The processor may read out a field extending over multiple rows and may check the value of the entire field in this manner. If bits 76 do not have the proper values, processor 32 may determine the readout to be illegal and may take appropriate protective action, as described above. Device 72 and/or processor 32 may optionally implement a back-up scheme so that failure of a single bit does not render the device unusable.

Although the embodiments described above relate particularly to situations in which the words <00 . . . 000> and <11 . . . 111> are defined as illegal, it is also possible to define other patterns of bits, containing both ones and zeros, as illegal. For example, a word containing a particular sequence of ones and zeros may be defined as illegal, and one or more of the bits in the memory array may be permanently fixed at a value that breaks this sequence. These values of these fixed bits are treated upon readout in the manner described above.

Furthermore, although the above embodiments refer mainly to readout and verification of fields of data held in binary memory cells, the principles set forth above may be applied to any predefined range of data that is read out of any sort of memory array concurrently. One or more cells in the range are permanently fixed, at the time of manufacture, to a certain assigned values, while other cells in the range may be programmed subsequently. The cells in the range may each store a single bit, as in the examples described above, or they may store two or more bits of data, as in multi-level memory cells that are known in the art. In the latter case, the fixed and programmable “values” read out of the cells, and the patterns against which these values are tested, may comprise multi-bit values rather than the binary values in the embodiments described above. In any case, upon readout of the range, if the fixed cell or cells do not have the assigned values in the readout data, protective action may be taken.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An electronic device, comprising:
an array of memory cells, comprising at least one range of the cells in which at least one cell is permanently fixed during manufacture of the device to have a given value, while others of the cells in the at least one range are permitted to be programmed subsequently; and
a readout circuit, which is configured to concurrently read out all the cells in the at least one range, including the at least one permanently-fixed cell and the cells that are permitted to be programmed subsequently,
wherein a readout in which the at least one cell has a value different from the given value is defined as an illegal readout.

2. The device according to claim 1, wherein the at least one cell comprises at least a first cell that is permanently fixed at a first value and at least a second cell that is permanently fixed at a second value.

3. An electronic device, comprising:
a readout circuit, which is configured to read one or more fields of data out of the device, each field comprising multiple bits, each bit configured to have either a first or a second value, the one or more fields including a protected field for which a readout in which all the bits have the first value is defined as an illegal readout; and
an array of memory cells coupled to the readout circuit and configured to hold the bits of the one or more fields, such that at least one cell in the protected field is permanently fixed during manufacture of the device to have the second value, while others of the cells in the protected field are permitted to be programmed subsequently.

4. The device according to claim 3, wherein the readout circuit is configured to read out all the cells in the protected field concurrently from the electronic device.

5. The device according to claim 3, wherein for the protected field, a first readout in which the bits are all zero and a second readout in which the bits are all one are defined as illegal readouts, and wherein among the cells of the protected field in the array, at least a first cell is fixed to be permanently one and at least a second cell is fixed to be permanently zero.

6. The device according to claim 1, wherein the array of the memory cells is configured to store data content in the others of the cells that are permitted to be programmed subsequently.

7. The device according to claim 6 wherein the data content comprises a security configuration field value.

8. The device according to claim 1, wherein the array contains one or more rows of the memory cells, and wherein the at least one cell is located in one of the rows.

9. The device according to claim 1, wherein the array contains one or more rows of the memory cells, and wherein the at least one cell is located outside the rows of the array.

10. The device according to claim 9, wherein the readout circuit comprises first sense amplifiers for reading out the data stored in the array, and at least one second sense amplifier for reading out the at least one cell.

11. A method for data protection, the method comprising:
in an array of memory cells in an electronic device, permanently fixing during manufacture at least one cell in a range of the cells to have a given value, while others of the cells in the range are permitted to be programmed subsequently;
configuring a readout circuit to concurrently read out all the cells in the range, including the at least one permanently-fixed cell and the cells that are permitted to be programmed subsequently; and
defining a readout in which the at least one cell has a value different from the given value as an illegal readout.

12. The method according to claim 11, wherein permanently fixing the at least one cell comprises fixing at least a first cell at a first value and at least a second cell at a second value.

13. A method for data protection, the method comprising:
identifying a protected field in an array of memory cells in an electronic device, the protected field comprising multiple bits, each bit configured to have either a first or a second value;
defining a readout from the protected field in which all the bits have the first value as an illegal readout; and
permanently fixing during manufacture of the device at least one cell in the protected field at the second value, while permitting others of the cells in the protected field to be programmed subsequently.

14. The method according to claim 13, wherein all the cells in the protected field are read out concurrently from the electronic device.

15. The method according to claim 13, wherein defining the readout comprises specifying a first readout in which the bits are all zero and a second readout in which the bits are all one as illegal readouts, and wherein permanently fixing the at least one cell comprises setting at least a first cell to be permanently one and at least a second cell to be permanently zero.

16. The method according to claim 11, wherein the method comprises storing data content in the others of the cells that are permitted to be programmed subsequently.

17. The method according to claim 16, wherein the data content comprises a security configuration field value.

18. The method according to claim 11, wherein the array contains one or more rows of the memory cells, and wherein the at least one cell is located in one of the rows.

19. The method according to claim 11, wherein the array contains one or more rows of the memory cells, and wherein the at least one cell is located outside the rows of the array.

20. The method according to claim 19, wherein the array is coupled to first sense amplifiers for reading out data stored in the memory, and wherein the method comprises providing at least one second sense amplifier for reading out the at least one cell.

21. The device according to claim 3, wherein the memory cells are non-volatile programmable memory cells.

22. The method according to claim 13, wherein the memory cells are non-volatile programmable memory cells.

23. A data protection apparatus for an electronic device comprising:
means for permanently fixing during manufacture at least one cell in a range of the cells to have a given value, while others of the cells in the range are permitted to be programmed subsequently, wherein the range of cells is in an array of memory cells in the electronic device;
means for configuring a readout circuit to concurrently read out all the cells in the range, including the at least one permanently-fixed cell and the cells that are permitted to be programmed subsequently; and
means for defining a readout in which the at least one cell has a value different from the given value as an illegal readout.
